(19) United States
(12) Patent Application Publication
(10) Pub. No.: US 2006/0133332 A1
(43) Pub. Date: Jun. 22, 2006

(54) Method and apparatus for providing radio configuration parameters to mobile access points

(75) Inventor: Murali Achanta, Los Altos, CA (US)

Correspondence Address: SIERRA PATENT GROUP, LTD., 1657 Hwy 395, Suite 202, Minden, NV, 89423, US

(73) Assignee: Cisco Technology, Inc.

(21) Appl. No.: 11/016,424

(22) Filed: Dec. 16, 2004

(51) Int. Cl. H04L 12/28

(52) U.S. Cl. 370/338; 370/401

(57) ABSTRACT

Method and apparatus for automatically configuring access points are disclosed. A wired interface is configured to detect the presence of a wireless access point on a network. The wired interface then embeds radio configuration parameters in a message and sends said message to the access point. The message may be encoded as a DHCP message, and may be provided to the access point in response to a request from the access point for an IP address. Parameters such as transmit power level, country code, and reserved channels may be sent to the access point, and the access point may then be configured itself in accordance with the parameters at startup.

### BACKGROUND

1. Field of the Disclosure

The disclosure relates generally to wireless communications, and in particular, to wireless access points.

2. The Prior Art

Background

The use of wireless networks has become prevalent throughout the modern workplace. For example, retail stores and warehouses may use a wireless local area network (LAN) to track inventory and replenish stock, and office environments may use a wireless LAN to share computer peripherals. Additionally, wireless LANs are becoming more common for personal use, such as in the home or at public meeting places, known as Internet “hot-spots”.

A wireless LAN offers several advantages over regular LANs. For example, users are not confined to locations previously wired for network access, wireless work stations are relatively easy to link with an existing LAN without the expense of additional cabling or technical support; and wireless LANs provide excellent alternatives for mobile or temporary working environments.

In general there are two types of wireless LANs, independent and infrastructure wireless LANs. The independent, or peer-to-peer, wireless LAN is the simplest configuration and connects a set of personal computers with wireless adapters. Any time two or more wireless adapters are within range of each other, they can set up an independent network.

In infrastructure wireless LANs, multiple base stations link the wireless LAN to the wired network and allow users to efficiently share network resources. The base stations not only provide communication with the wired network, but also mediate wireless network traffic in the immediate neighborhood. Both of these network types are discussed extensively in the IEEE 802.11 standard for wireless LANs.

In the majority of applications, wireless LANs are of the infrastructure type. That is, the wireless LAN typically includes a number of fixed base stations, also known as access points, interconnected by a cable medium to form a hardwired network. The hardwired network is often referred to as a system backbone and may include many distinct types of nodes, such as, host computers, mass storage media, and communications ports. Also included in the typical wireless LAN are intermediate base stations which are not directly connected to the hardwired network.

These intermediate base stations, often referred to as wireless base stations, increase the area within which base stations connected to the hardwired network can communicate with mobile terminals. Associated with each base station is a geographical cell. A cell is a geographic area in which a base station has sufficient signal strength to transmit data to and receive data from a mobile terminal with an acceptable error rate. Unless otherwise indicated, the term base station will hereinafter refer to both base stations hardwired to the network and wireless base stations. Typically, the base station connects to the wired network from a fixed location using standard Ethernet cable, although in some case the base station may function as a repeater and have no direct link to the cable medium. Minimally, the base station receives, buffers, and transmits data between the wireless local area network (WLAN) and the wired network infrastructure. A single base station can support a small group of users and can function within a predetermined range.

In general, end users access the wireless LAN through wireless LAN adapters, which are implemented as PC cards in notebook computers, ISA or PCI cards in desktop computers, or fully integrated devices within hand-held computers. Wireless LAN adapters provide an interface between the client network operating system and the airwaves. The nature of the wireless connection is transparent to the network operating system.

In general operation, when a mobile terminal is powered up, it “associates” with a base station through which the mobile terminal can maintain wireless communication with the network. In order to associate, the mobile terminal must be within the cell range of the base station and the base station must likewise be situated within the effective range of the mobile terminal. Upon association, the mobile unit is effectively linked to the entire LAN via the base station. As the location of the mobile terminal changes, the base station with which the mobile terminal was originally associated may fall outside the range of the mobile terminal. Therefore, the mobile terminal may “de-associate” with the base station it was originally associated to and associate with another base station which is within its communication range. Accordingly, wireless LAN topologies must allow the cells for a given base station to overlap geographically with cells from other base stations to allow seamless transition from one base station to another.

Most wireless LANs, as described above, use spread spectrum technology. Spread spectrum technology is a wideband radio frequency technique developed by the military for use in reliable, secure, mission-critical communication systems. A spread spectrum communication system is one in which the transmitted frequency spectrum or bandwidth is much wider than absolutely necessary. Spread spectrum is designed to trade off bandwidth efficiency for reliability, integrity, and security. That is, more bandwidth is consumed than in the case of narrowband transmission, but the tradeoff produces a signal that is, in effect, louder and thus easier to detect, provided that the receiver knows the parameters of the spread spectrum signal being broadcast. If a receiver is not tuned to the right frequency, a spread spectrum signal looks like background noise.

In practice, there are two types of spread spectrum architectures: frequency hopping (FH) and direct sequence (DS). Both architectures are defined for operation in the 2.4 GHz industrial, scientific, and medical (ISM) frequency band. Each occupies 83 MHz of bandwidth ranging from 2.400 GHz to 2.483 GHz. Wideband frequency modulation is an example of an analog spread spectrum communication system.

In frequency hopping spread spectrum systems the modulation process contains the following two steps: 1) the original message modulates the carrier, thus generating a narrow band signal; 2) the frequency of the carrier is periodically modified (hopped) following a specific spreading code. In frequency hopping spread spectrum systems, the spreading code is a list of frequencies to be used for the carrier signal. The amount of time spent on each hop is known as dwell time. Redundancy is achieved in FHSS systems by the possibility to execute re-transmissions on frequencies (hops) not affected by noise.

Direct sequence is a form of digital spread spectrum. With regard to direct sequence spread spectrum (“DSSS”), the transmission bandwidth required by the baseband modulation of a digital signal is expanded to a wider bandwidth by using a much faster switching rate than used to represent the original bit period. In operation, prior to transmission, each original data bit to be transmitted is converted or coded to a sequence of a “sub bits” often referred to as “chips” (having logic values of zero or one) in accordance with a conversion algorithm. The coding algorithm is usually termed a spreading function. Depending on the spreading function, the original data bit may be converted to a sequence of five, ten, or more chips. The rate of transmission of chips by a transmitter is defined as the “chipping rate.”

As previously stated, a spread spectrum communication system transmits chips at a wider signal bandwidth (broadband signal) and a lower signal amplitude than the corresponding original data would have been transmitted at baseband. At the receiver, a despreading function and a demodulator are employed to convert or decode the transmitted chip code sequence back to the original data on baseband. The receiver, of course, must receive the broadband signal at the transmitter chipping rate.

The coding scheme of a spread spectrum communication system utilizes a pseudo-random binary sequence (“PRSB”). In a DSSS system, coding is achieved by converting each original data bit (zero or one) to a predetermined repetitive pseudo noise (“PN”) code.

A PN code length refers to a length of the coded sequence (the number of chips) for each original data bit. As noted above, the PN code length effects the processing gain. A longer PN code yields a higher processing gain which results in an increased communication range. The PN code chipping rate refers to the rate at which the chips are transmitted by a transmitter system. A receiver system must receive, demodulate and despread the PN coded chip sequence at the chipping rate utilized by the transmitter system. At a higher chipping, the receiver system is allotted a smaller amount of time to receive, demodulate and despread the chip sequence. As the chipping rate increases so to will the error rate. Thus, a higher chipping rate effectively reduces communication range. Conversely, decreasing the chipping rate increases communication range. The spreading of a digital data signal by the PN code effect overall signal strength (or power) of the data be transmitted or received. However, by spreading a signal, the amplitude at any one point typically will be less than the original (non-spread) signal.

It will be appreciated that increasing the PN code length or decreasing the chipping rate to achieve a longer communication range will result in a slower data transmission rate. Correspondingly, decreasing the PN code length or increasing the chipping rate will increase data transmission rate at a price of reducing communication range.

FIG. 1 schematically illustrates a typical transmitter system 100 of a DSSS system. Original data bits 101 are input to the transmitter system 100. The transmitter system includes a modulator 102, a spreading function 104 and a transmit filter 106. The modulator 102 modulates the data using a well known modulation technique, such as binary phase shift keying (“BPSK”), quadrature phase shift keying (QPSK), and complimentary code keying (CCK). In the case of the BPSK modulation technique, the carrier is transmitted in-phase with the oscillations of an oscillator or 180 degrees out-of-phase with the oscillator depending on whether the transmitted bit is a “0” or a “1”. The spreading function 104 converts the modulated original data bits 101 into a PN coded chip sequence, also referred to as spread data. The PN coded chip sequence is transmitted via an antenna so as to represent a transmitted PN coded sequence as shown at 108.

FIG. 1 also illustrates a typical receiver system or assembly, shown generally at 150. The receiver system includes a receive filter 152, a despreading function 154, a bandpass filter 156 and a demodulator 158. The PN coded data 108 is received via an antenna and is filtered by the filter 152. Thereafter, the PN coded data is decoded by a PN code despreading function 1544. The decoded data is then filtered and demodulated by the filter 156 and the demodulator 158 respectively to reconstitute the original data bits 101. In order to receive the transmitted spread data, the receiver system 150 must be tuned to the same predetermined carrier frequency and be set to demodulate a BPSK signal using the same predetermined PN, code.

More specifically, to receive a spread spectrum transmission signal, the receiver system must be tuned to the same frequency as the transmitter assembly to receive the data. Furthermore, the receiver assembly must use a demodulation technique which corresponds to the particular modulation techniques used by the transmitter assembly (i.e. same PN code length, same chipping rate, BPSK). Because multiple mobile terminals may communicate with a common base, each device in the cellular network must use the same carrier frequency and modulation technique.

One parameter directly impacted by the practice discussed in the preceding paragraph is “throughput.” Throughput or the rate of a system is defined as the amount of data (per second) carried by a system when it is active. As most communications systems are not able to carry data 100% of the time, an additional parameter, throughput, is used to measure system performance. In general, throughput is defined as the average amount of data (per second) carried by the system and is typically measured in bits per second (“bps”). The average is calculated over long periods of time. Accordingly, the throughput of a system is lower than its rate. When looking for the amount of data carried, the overhead introduced by the communication protocol should also be considered. For example, in an Ethernet network, the rate is 10 Mbps, but the throughput is only 3 Mbps to 4 Mbps.

One advantage of DSSS systems over FHSS systems is that DSSS systems are able to transmit data 100% of the time, having a high throughput. For example, systems operating at 11 Mbps over the air carry about 6.36 Mbps of data; FHSS systems can not transmit 100% of the available time. Some time is always spent before and after hopping from one frequency to another for synchronization purposes. During these periods of time, no data is transmitted. Obviously, for the same rate over the air, a FHSS system will have a lower throughput than an equivalent DSSS system.

Based on the IEEE 802.11 specifications, the maximum number of DSSS systems that can be collocated is three. These three collocated systems provide a brut aggregate throughput of 3.times.11 Mbps=33 Mbps, or a net aggregate throughput of 3 times 6.36 Mbps=19.08 Mbps. Because of the rigid allocation of sub-bands to systems, collisions between signals generated by collocated systems do not occur, and therefore the aggregate throughput is a linear function of the number of systems. FHSS technology allows the collocation of much more than 3 systems. However, as the band is allocated in a dynamic way among the collocated systems (they use different hopping sequences which are not synchronized), collisions do occur, lowering the actual throughput. The greater the number of collocated systems (base stations or access points), the greater the number of collisions and the lower the actual throughput. For small quantities of base stations or access points, each additional base station or access point brings in almost all its net throughput; the amount of collisions added to the system is not significant. When the number of base stations or access points reaches 15, the amount of collisions generated by additional access points is so high that in total they lower the aggregate throughput.

In view of the foregoing, there are some important advantages in using DSSS. However, there are some drawbacks to using DSSS.

One drawback to using DSSS relates to the selection of an operating frequency when a DSSS access point is added to an existing LAN, or when a new access point is first started in a congested area. In this regard, when an access point is added to an existing LAN, an operating frequency for the access point must be selected. This operating frequency is the one which will be used for communications between the newly added DSSS access point and other communication devices in the network (e.g., mobile units and other access points). In accordance with prior art practice, selection of the operating frequency for the newly added DSSS access point is performed manually. More specifically, a user determines which frequency is most suitable by determining and evaluating a variety of communication parameters, and then operating a computer on the network to select an operating frequency for the access point. This manual selection procedure is inefficient and time consuming. Moreover, it often does not result in an optimized configuration, and in fact, may result in serious errors in the frequency selection which impair communications in the existing LAN. With regard to optimized configurations, it should be recognized that multiple access points in an LAN may be operating on the same frequency. Therefore, it is desirable to allocate frequencies to access points in a manner which evenly distributes the number of access points operating on the same frequency.

Moreover, in accordance with IEEE 802.11, some of the operating frequencies are “overlapping,” while others are “non-overlapping.” It is preferred that “non-overlapping” frequencies be selected, and the number of access points operating on the same frequencies are evenly distributed. It is also desirable for optimized communications, to evaluate the loads associated with each access point, and its corresponding frequencies. Thus, the operating frequency for the new access point can be selected such that it is not a frequency used by an access point with a high load.

Additionally, it is contemplated that all non-overlapping frequencies may be occupied when a new access point starts up, as access points are becoming more common. For example, newer technologies allow users to install personal access points in locations such as hotels and apartment buildings. In such cases, overlapping radio cells may result from numerous users installing mobile access points in close proximity to each other.

### BRIEF DESCRIPTION OF THE DRAWING FIGURES

FIG. 1 is a schematic diagram of a typical transmitter and receiver system of a DSSS communication system;

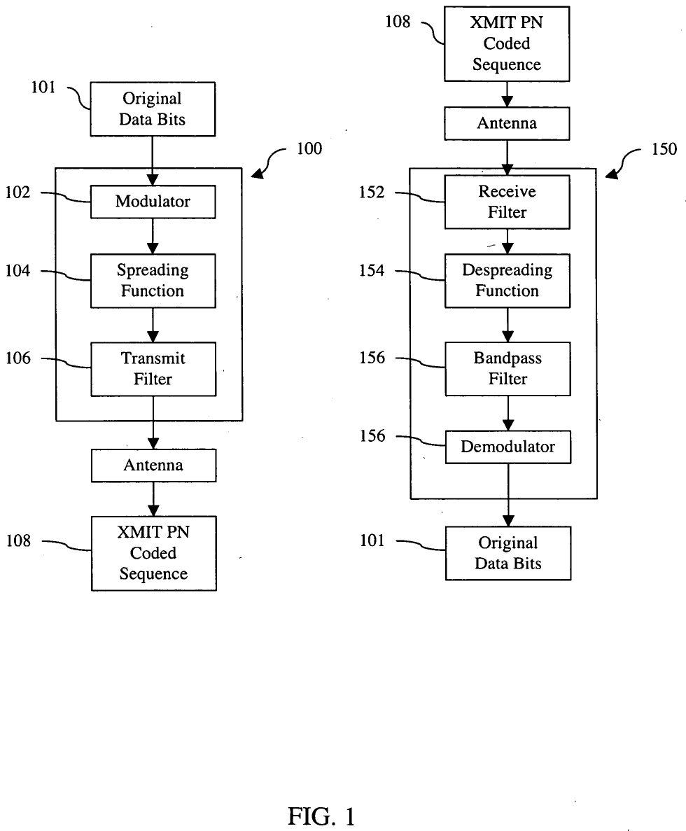

FIG. 2A is a schematic diagram of a typical wireless LAN system;

FIG. 2B is a block diagram of a typical wireless base station;

FIG. 3 is a table of DSSS frequencies specified by the IEEE 802.11 standard;

FIG. 4 is a flow diagram of a method for automatically configuring an access point in accordance with the teachings of this disclosure; and

FIG. 5 is a flow diagram of a method for passing radio parameters to an access point using DHCP in accordance with the teachings of this disclosure.

### DETAILED DESCRIPTION

Persons of ordinary skill in the art will realize that the following description is illustrative only and not in any way limiting. Other modifications and improvements will readily suggest themselves to such skilled persons having the benefit of this disclosure. In the following description, like reference numerals refer to like elements throughout.

This disclosure may relate to data communications. Various disclosed aspects may be embodied in various computer and machine readable data structures. Furthermore, it is contemplated that data structures embodying the teachings of the disclosure may be transmitted across computer and machine readable media, and through communications systems by use of standard protocols such as those used to enable the Internet and other computer networking standards.

The disclosure may relate to machine readable media on which are stored various aspects of the disclosure. It is contemplated that any media suitable for retrieving instructions is within the scope of the present disclosure. By way of example, such media may take the form of magnetic, optical, or semiconductor media, and may be configured to be accessible by a machine as is known in the art.

Various aspects of the disclosure may be described through the use of flowcharts. Often, a single instance of an aspect of the present disclosure may be shown. As is appreciated by those of ordinary skill in the art, however, the protocols, processes, and procedures described herein may be repeated continuously or as often as necessary to satisfy the needs described herein.

Accordingly, the representation of various aspects of the present disclosure through the use of flowcharts should not be used to limit the scope of the present disclosure.

It should be appreciated that a preferred embodiment of the present invention as described herein makes particular reference to the IEEE 802.11 standard, and utilizes terminology referenced therein. However, it should be understood that reference to the IEEE 802.11 standard and its respective terminology is not intended to limit the scope of the present invention. In this regard, the present invention is suitably applicable to a wide variety of other communication systems that utilize a plurality operating frequencies for data transmission.

It should be appreciated that the terms “access point,” “base station” and “controller” are used interchangeably herein. Furthermore it should be understood that in a typical WLAN configuration, an access point (e.g., transceiver device) connects to a wired network from a fixed location using a standard Ethernet cable. Typically, the access point receives, buffers, and transmits data between the wireless network (e.g., WLAN) and a wired network. A single access point can support a small group of users and can function within a range of less than one hundred feet to several hundred feet. End users access the WLAN through wireless LAN adapters, which may be implemented as PC cards in notebook computers, ISA or PCI cards in a desktop computer, or fully integrated devices within hand held computers. The WLAN adapters provide an interface between the client network operating system (NOS) and the airwaves (via an antenna).

Moreover, it should be appreciated that while the present invention has been described in connection with a wireless local area network (WLAN), the present invention is suitable for use in connection with other types of wireless networks, including a wireless wide area network (WWAN), a wireless metropolitan area network (WMAN) and a wireless personal area network (WPAN).

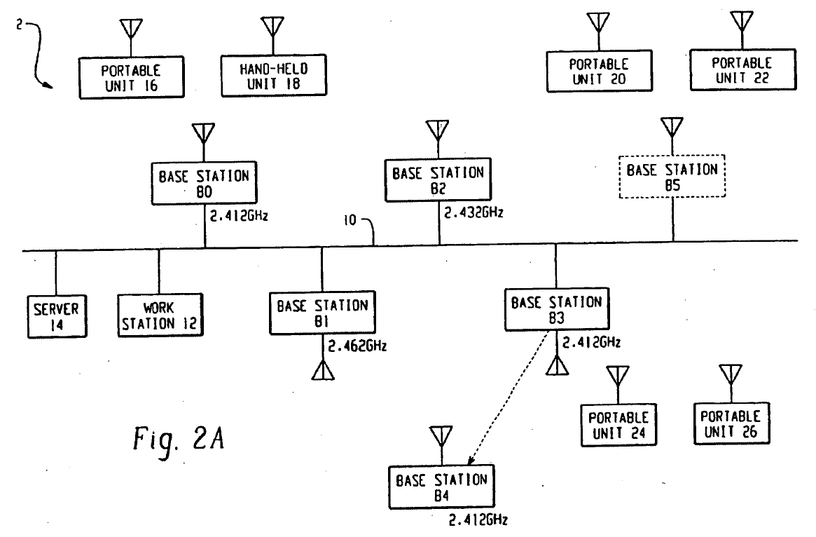

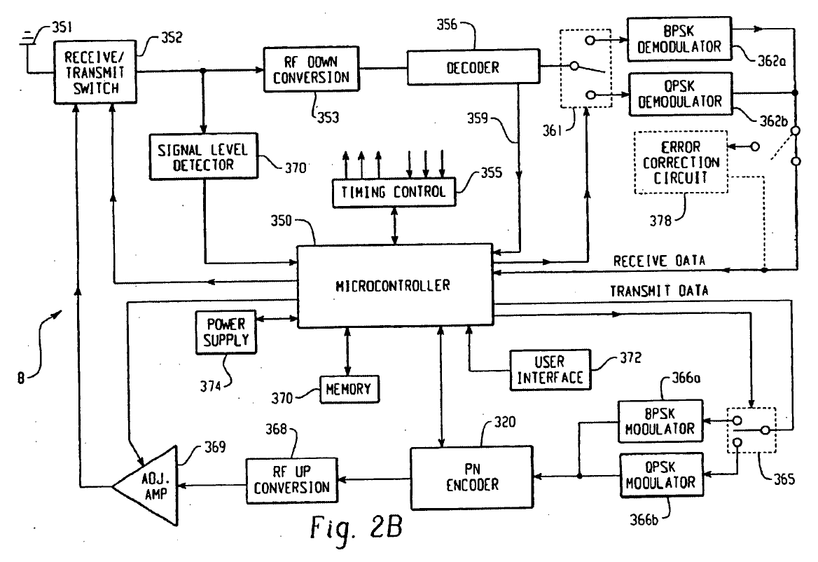

Referring now to FIG. 2A, there is shown a typical wireless network used with the present invention. More specifically, FIG. 2A shows a wireless LAN system 2 generally comprised of a plurality of communication devices including mobile stations (i.e., portable units 16, 20, 22, 24 and 26, and hand-held unit 18) and a plurality of base stations (or access points or controller) B0, B1, B2, B3 and B4. The base stations may be connected to a hardwired network backbone or serve as wireless base stations. Each base station can transmit and receive data in its respective cell. Wireless LAN system 2 also includes a cable medium, namely, an Ethernet cable 10, along which all network data packets are transmitted when conveyed between any two network nodes. The principal nodes are direct-wired to the cable 10. These include a work station 12 and a network server 14, but may include a mainframe computer, communication channels, shared printers and various mass storage devices.

In wireless LAN system 2, base station B4 effectively operates as a repeater or extender, coupled to the cable 10 by the base station B3 and a radio link with the base station B3. Base station B4 has been termed a “base station” because it registers mobile stations in the same manner as the base stations that are direct-wired to the cable 10, and offers the same basic registration services to the mobile stations. The base station B4 and each device to which it offers packet transferring services will, however, be registered with the base station B3 to ensure that packets intended for or transmitted by devices associated with the base station B4 are properly directed through the base station B4.

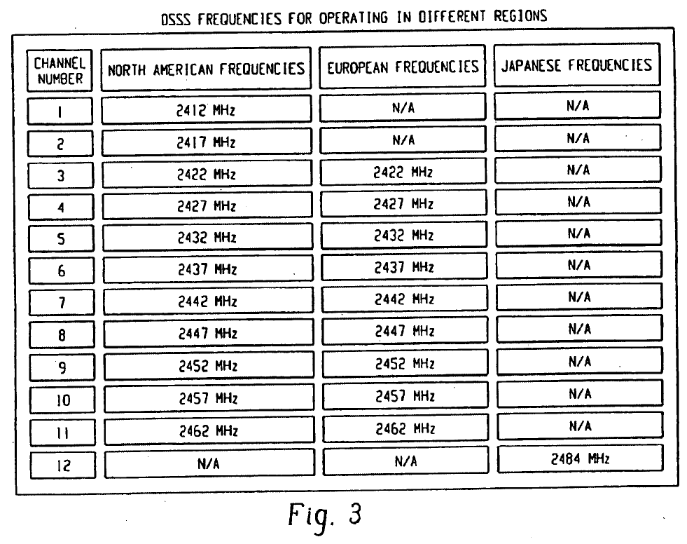

Each of the base stations B0-B4 may use DSSS (discussed above) as a communications protocol. Accordingly, each of the base stations will have an operating frequency which it utilizes for communications with the associated mobile units. This operating frequency is selected from the list of operating frequencies shown in the table of FIG. 3. In some cases, more than one base unit will be using the same operating frequency. When an additional base station, such as base station B5 is added to a preexisting wireless LAN, the present invention provides a system for dynamically determining the least congested operating frequency for the newly added base station or to the existing base station willing to change to new channel, as will be described in further detail below.

General operation of representative wireless LAN network 2, as discussed above, is known to those skilled in the art, and is more fully discussed in U.S. Pat. No. 5,276,680, which is fully incorporated herein by reference.

FIG. 2B shows an exemplary embodiment of a typical base unit B. Base unit B includes conventional components, including an antenna 351 for receiving and transmitting data via RF, an RF down conversion circuit 353, an optional signal level detector 370 (e.g., a conventional received signal strength indicator (RSSI)), a decoder 356, BPSK and QPSK demodulators 362a, 362b which are selectable by switching means 361, a microcontroller 350, timing control circuit 355, memory 370, user interface 372, and power supply 374. For transmitting data, Base unit B further includes BPSK and QPSK modulators 366a, 366b which are selectable by switch means 365, PN encoder 320, an RF up conversion circuit 368 and adjustable gain RF output amplifier 369. These components are more fully described in U.S. Pat. No. 5,950,124, which is fully incorporated herein by reference. It should be appreciated that BPSK and QPSK modulators/demodulators are shown only to illustrated the present invention, and that other modulation/demodulation techniques are in common use, including BMOK and CCK.

In a preferred embodiment, the base station may be configured to collect and publish client and traffic related data. For example, it is contemplated that the base stations of this disclosure may be configured to publish the number of associated clients and traffic statistics such as input and output rates. It is contemplated that a software extension may be provided to compile and publish data regarding associated clients and traffic.

Due to the ever evolving and constantly changing demands of the modern workplace, it may become advantageous to add additional hardware to existing wireless network. In particular, it may be beneficial to add one or more base stations to an existing wireless network, thereby providing a larger geographical area of coverage for the network and accommodating additional users.

One important consideration that must be addressed when adding a base station to an existing LAN is the need to determine the operating frequency of the newly added base station. The selected operating frequency will be used to communicate with mobile units that the base station must support. The physical layer in a network defines the modulation and signaling characteristics for the transmission of data. As previously stated, one typical RF transmission techniques involves direct sequence spread spectrum (DSSS). In the United States, DSSS is defined for operation in the 2.4 GHz (ISM) frequency band, and occupies 83 MHz of bandwidth ranging from 2.400 GHz to 2.483 GHz. However, in other geographic regions different frequencies are allocated.

FIG. 3 shows the frequency allocation in North America, Europe and Japan, in accordance with IEEE 802.11. As can be readily appreciated from FIG. 3, there are a total of twelve (12) channels capable of supporting the DSSS architecture. However, in North America only channels 1-11 are allocated, in Europe only channels 3-11 are allocated and in Japan only channel 12 is allocated.

Though the foregoing discussion used a DSSS example operating in the 2.4 GHz band, it is to be understood that the teachings of this disclosure may apply to other technologies and frequencies. For example, the teachings of this disclosure may apply to OFDM systems, and systems operating at 5 GHz.

The present disclosure provides for the automatic configuration and setup of the configurable radio parameters of an access point at startup. During the procedure, the access point receives radio parameters from a server responsive to a request from the access point for radio parameters. The access point may receive the parameters via DHCP. It is contemplated that this process may be performed at startup when an access point desires to join an existing infrastructure network. Alternatively, the process may be performed whenever desired by a network administrator.

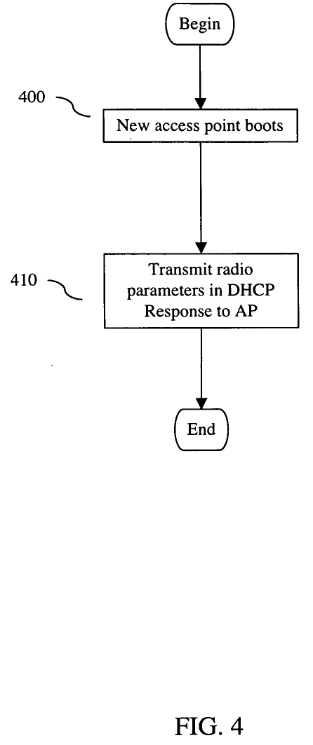

FIG. 4 is a flow diagram of a method for automatically configuring an access point. The process begins in act 400, when an access point boots up and desires to join a network. It is contemplated that any event that makes the server aware of the access point's presence may trigger the process of this disclosure. In a preferred embodiment, the disclosed process and configuration preferably occurs prior to the access point turning on its' radio transmitter.

After startup of an access point, the radio parameters are requested for the access point in act 410. It is contemplated that a wide variety of parameters may be requested for the access point. For example, the 802.11 wireless transmit power level may be sent to the access point, as well as the country code, or reserved channels.

In one embodiment, the AP sends a DHCP Request for radio parameters to the wired network via a wired Ethernet interface. The DHCP server on the wired interface receives the DHCP Request, and prepares a DHCP Response packet and sends it to the AP. In preparing the response packet, the DHCP server embeds radio configuration parameter values in the response. The AP receives the DHCP Response and configures the radio according to the provided parameter values.

Using the benefits of this disclosure, an access point may be automatically configured upon startup to operate in a desired manner. For example, in a hotel, where many guests may plug mobile access points into the wired network, the access point may be configured to transmit at a lower power level so as to minimize overlapping radio cells. In such a fashion, the hotel's network administration may effectively manage the transmit power of access points depending on room size or other environmental factors to allow multiple rooms to have their own cell without interfering with other rooms.

Likewise, the country code may be passed to the access point, allowing the access point to properly generate and publish channel information in its' beacon, thereby allowing clients to properly follow according to 802.11. It is contemplated that the transmit power value may also be published to clients so that client devices may also accordingly follow desired transmit power levels.

It is contemplated that any option configurable in the access point may be transmitted by the wired interface.

One preferred embodiment illustrating how radio parameters may be transmitted to an access point will now be disclosed.

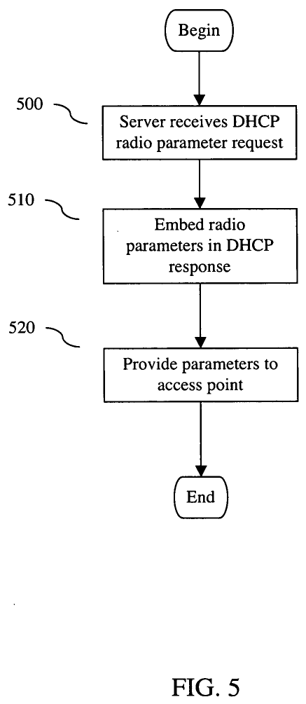

FIG. 5 is a flow diagram of a method for passing radio parameters to an access point using DHCP. The process begins in act 500, where a wired interface receives a request to provide an access point with required radio parameters. As mentioned above, though an explicit DHCP request is disclosed as a exemplary triggering event, any event may be employed that makes the wired interface aware of the access point's existence on the network.

In act 510, the desired radio parameters are embedded in a DHCP message.

As is known by those skilled in the art. The Dynamic Host Configuration Protocol (DHCP) provides a framework for passing configuration information to hosts on a Transmission Control Protocol/Internet Protocol (TCP/IP) network. Configuration parameters and other control information are carried in tagged data items that are stored in the ‘options’ field of the DHCP message.

For example, to communicate the offset of the client's subnet in seconds from Coordinated Universal Time (UTC), a time offset field is provided as option code 2. The offset is expressed as a signed 32-bit integer occupying 4 octets.

An example of such a datagram is:

Code Len Time Offset
+-----+-----+-----+-----+-----+-----+
| 2 | 4 | n1 | n2 | n3 | n4 |
+-----+-----+-----+-----+-----+-----+

An option for providing the country code to an access point may be as follows:

Code Len enc 802.11 Country Code
+-------+-----+------+------+------+------+------+
| TBD | n | 1 | p1 | p2 | p3 | p4 |
+-------+-----+------+------+------+------+------+

An option for providing a list of reserved wireless channels to an access point may be as follows:

```
          Code Len enc 802.11 Wireless reserved
channels
      +-------+-----+------+------+------+------+------+
      | TBD | n | 2 | p1 | p2 | p3 | p4 |
      +-------+-----+------+------+------+------+------+
```

In act 520, the radio parameters are passed to the access point in a DHCP message having an option code indicating that radio configuration parameters are included in the message. The access point may then utilize the provided parameters to configure itself upon startup to operate in the manner desired by the wired interface.

As can be seen from the foregoing discussion, an access point management protocol has been disclosed that automatically configures access points at startup to behave in a predetermined manner as dictated by a host wired interface server. There is no need for intervention from the access point's user; all configuration is done by the host interface as dictated by the network administrator. Parameters such as transmit power levels, choice of available channels, and other parameters may be configured.

While embodiments and applications of this disclosure have been shown and described, it would be apparent to those skilled in the art that many more modifications and improvements than mentioned above are possible without departing from the inventive concepts herein. The disclosure, therefore, is not to be restricted except in the spirit of the appended claims.

What is claimed is:

1. A method for automatically configuring an access point, said method comprising:
detecting, by a wired interface, the presence of a wireless access point on a network;
embedding, by said wired interface, radio configuration parameters in a message; and
sending said message to said access point.

2. The method of claim 1, wherein said message comprises a DHCP response.

3. The method of claim 2, wherein said DHCP response contains an indication that said message contains radio configuration parameters.

4. The method of claim 3, wherein said message is provided to said wireless access point responsive to a request for an IP address.

5. An apparatus for automatically configuring an access point comprising:
a wired interface network management device, said device configured to:
detect the presence of a wireless access point on a network;
embed radio configuration parameters in a message; and
send said message to said access point.

6. The apparatus of claim 5, wherein said message comprises a DHCP response.

7. The apparatus of claim 6, wherein said DHCP response contains an indication that said message contains radio configuration parameters.

8. The apparatus of claim 7, wherein said message is provided to said wireless access point responsive to a request for an IP address.

9. An apparatus for automatically configuring an access point comprising:
means for detecting the presence of a wireless access point on a network;
means for embedding radio configuration parameters in a message; and
means for sending said message to said access point.

10. The apparatus of claim 9, wherein said message comprises a DHCP response.

11. The apparatus of claim 10, wherein said DHCP response contains an indication that said message contains radio configuration parameters.

12. The apparatus of claim 11, wherein said message is provided to said wireless access point responsive to a request for an IP address.
